(19) United States
(12) Patent Application Publication
(10) Pub. No.: US 2026/0292814 A1
(43) Pub. Date: Sep. 24, 2026

(54) METHOD AND APPARATUS FOR HARQ-ACK TRANSMISSION IN MOBILE COMMUNICATIONS

(71) Applicant: MEDIATEK SINGAPORE PTE. LTD., Singapore (SG)

(72) Inventors: Jozsef Gabor NEMETH, Cambridge (GB); Mohammed S Aleabe AL-IMARI, Cambridge (GB); Sylvio Paul Mathieu BARDES, Cambridge (GB); Pradeep JOSE, Cambridge (GB)

(73) Assignee: MEDIATEK SINGAPORE PTE. LTD., Singapore (SG)

(21) Appl. No.: 19/475,395

(22) PCT Filed: Oct. 11, 2024
(86) PCT No.: PCT/CN2024/124105

§ 371 Date: Oct. 14, 2025

Related U.S. Application Data
(60) Provisional application No. 63/589,344, filed on Oct. 11, 2023.

(51) Int. Cl. H04W 72/1263; H04L 5/00

(52) U.S. Cl. CPC H04W 72/1263; H04L 5/0055

(57) ABSTRACT

Various solutions for hybrid automatic repeat request-acknowledgment (HARQ-ACK) transmission with respect to an apparatus in mobile communications are described. The apparatus may receive a downlink control information (DCI). The apparatus may schedule a HARQ-ACK codebook associated with the DCI onto a physical uplink shared channel (PUSCH) without uplink (UL) data. The apparatus may transmit the PUSCH.

### CROSS REFERENCE TO RELATED PATENT APPLICATION(S)

The present disclosure is part of a non-provisional application claiming the priority benefit of U.S. Patent Application No. 63/589,344, filed 11 Oct. 2023, the content of which herein being incorporated by reference in its entirety.

### TECHNICAL FIELD

The present disclosure is generally related to mobile communications and, more particularly, to hybrid automatic repeat request-acknowledgment (HARQ-ACK) transmission with respect to apparatus in mobile communications.

### BACKGROUND

Unless otherwise indicated herein, approaches described in this section are not prior art to the claims listed below and are not admitted as prior art by inclusion in this section.

In Long-Term Evolution (LTE) or New Radio (NR) mobile communications, downlink control information (DCI) may include scheduling information for user equipment (UE) to receive or transmit data via scheduled network resources. More specially, based on a downlink (DL) DCI, the UE may receive a physical downlink shared channel (PDSCH) from the network node after k0 slot(s) which is (are) configured between the DL DCI and the PDSCH, and transmit a physical uplink control channel (PUCCH) (e.g., a PUCCH including HARQ-ACK) to the network node after k1 slot(s) which is (are) configured between the PDSCH and the PUCCH. Furthermore, based on an uplink (UL) DCI, the UE may transmit physical uplink shared channel (PUSCH) to the network node after k2 slot(s) which is (are) configured between the UL DCI and the PUSCH. In addition, from decoding the DL DCI to being ready to receive the PDSCH, N1 symbols represent the required time. From receiving an UL DCI to preparing the PUSCH transmission, N2 symbols represent the required time, which is used to ensure that the UE may have sufficient time to prepare the PUSCH transmission.

In some network scenarios, transmission overrides and transmission arbitrations may occur, and then be affected by various network conditions. For example, in some network scenarios on the same component carrier (CC) or across CCs, after receiving a DCI, the UE determines corresponding PDSCH and PUCCH including HARQ-ACK. Subsequently, the UE receives another DCI and determines corresponding PDSCH and PUCCH including HARQ-ACK, which causes HARQ uplink control information (UCI) reselection. The HARQ UCI delays all possible transmission arbitrations until N1 symbols before the last PUCCH. For another example, in some network scenarios across CCs, after receiving a DCI, the UE determines corresponding PUSCH including HARQ-ACK of PUCCH. Subsequently, the UE receives another DCI and determines corresponding PUSCH including HARQ-ACK of PUCCH. When the PUSCHs are determined overlapped with respect to time domain, PUSCH rate rematching is delayed until some transmission arbitrations (e.g., arbitrations between PUSCHs) are completed. Further, in some network scenarios, a configured grant may be overridden by a dynamic grant (e.g., grant for PUSCH) any time before timeline of N2 symbols starts. However, these transmission overrides, transmission arbitrations and potential delays may cause increases of computational complexity and overall network delays.

Accordingly, how to avoid transmission overrides, transmission arbitrations and potential delays becomes an important issue in the newly developed wireless communication network. Therefore, there is a need to provide proper HARQ-ACK transmission schemes to avoid transmission overrides, transmission arbitrations and potential delays.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to hybrid automatic repeat request-acknowledgment (HARQ-ACK) transmission with respect to apparatus in mobile communications.

In one aspect, a method may involve an apparatus receiving, a downlink control information (DCI). The method may further involve the apparatus scheduling a HARQ-ACK codebook associated with the DCI onto a physical uplink shared channel (PUSCH) without uplink (UL) data. The method may further involve the apparatus transmitting the PUSCH.

In one aspect, a method may involve an apparatus transmitting a DCI for scheduling a HARQ-ACK codebook associated with the DCI onto a PUSCH without UL data. The method may further involve the apparatus receiving the PUSCH.

In one aspect, an apparatus may comprise a transceiver which, during operation, wirelessly communicates with a wireless network. The apparatus may also comprise a processor communicatively coupled to the transceiver. The processor, during operation, may perform operations comprising receiving, by the transceiver, a DCI. The processor may further perform operations comprising scheduling a HARQ-ACK codebook associated with the DCI onto a PUSCH without UL data. The processor may further perform operations comprising transmitting the PUSCH.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to hybrid automatic repeat request-acknowledgment (HARQ-ACK) transmission with respect to apparatus in mobile communications. According to the present disclosure, a number of possible solutions may be implemented separately or jointly. That is, although these possible solutions may be described below separately, two or more of these possible solutions may be implemented in one combination or another.

Regarding the present disclosure, a network node may transmit a downlink control information (DCI) to a user equipment (UE). Based on the DCI, the UE may schedule a hybrid automatic repeat request-acknowledgment (HARQ-ACK) codebook associated with the DCI onto a physical uplink shared channel (PUSCH) without uplink (UL) data. In other words, the PUSCH may carry only the HARQ-ACK codebook associated with the DCI but may not carry any UL data. Then, the UE may transmit the PUSCH to the network node for reporting the HARQ-ACK codebook. Therefore, because the HARQ-ACK codebook may be transmitted by the dedicated PUSCH which is without UL data, some transmission arbitrations and transmission overrides (e.g., transmission arbitrations between HARQ-ACK related PUCCH and HARQ-ACK related PUCCH, or transmission overrides related to PUSCH overlapping with HARQ-ACK related PUCCH, etc.) may be avoided or ignored so that the related delays may not occur.

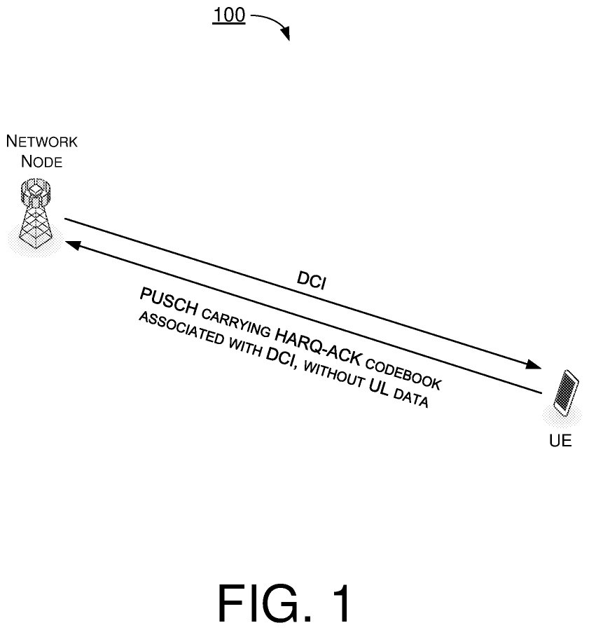

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

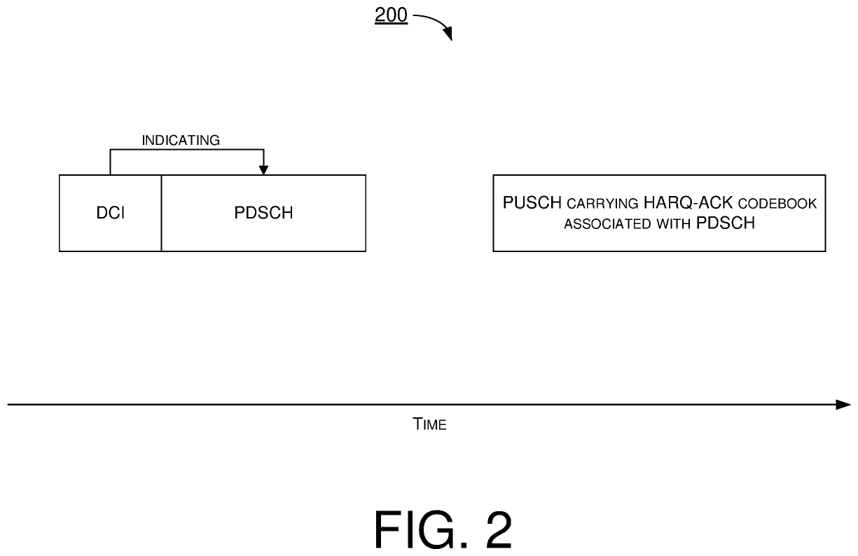

FIG. 2 illustrates an example scenario 200 under schemes in accordance with implementations of the present disclosure. In some embodiments, the network node may transmit a DCI to the UE. The DCI may indicate a PDSCH. For the PDSCH indicated by the DCI, the UE may schedule a HARQ-ACK codebook associated with the PDSCH indicated by the DCI onto a PUSCH without UL data. More specifically, the PUSCH may carry only the HARQ-ACK codebook associated with the PDSCH indicated by the DCI, but the PUSCH may not carry any UL data (i.e., the PDSCH is without uplink shared channel (UL-SCH)). Then, the UE may transmit the PUSCH to the network node for reporting the HARQ-ACK codebook associated with the PDSCH indicated by the DCI.

In some cases, the UE may not expect collision between the PUSCH only carrying HARQ-ACK codebook and any PUCCH carrying CSI. In some cases, the UE may allow collision between the PUSCH only carrying HARQ-ACK codebook and a PUCCH carrying CSI to occur, and the UE may drop the PUCCH. In some cases, when the HARQ-ACK codebook is for semi-persistent scheduling (SPS) PDSCH, the HARQ-ACK codebook may be scheduled onto configured grant.

In some implementations, the UE may multiplex the PUSCH to a dynamic grant scheduled for an UL data. In particular, when there is an UL data that needs to be transmitted, the UE may multiplex the PUSCH to the dynamic grant scheduled by the network node for transmitting the UL data. The UE may transmit the PUSCH multiplexed to the dynamic grant to the network node.

In some implementations, the UE may perform a multiplex procedure at layer 1 according to a scheme of uplink control information (UCI) over PUSCH. In particular, multiplexing at layer 1 may follow rules of UCI over PUSCH defined in 3rd generation partnership project (3GPP) specification. In brief, UCI may include HARQ-ACK, channel state information (CSI) and scheduling request (SR). Regarding the part of UCI including HARQ-ACK and CSI, the UCI may: (1) be encoded and transmitted through PUCCH; or (2) be multiplexed on the PUSCH. The HARQ-ACK (if any) and CSI (if any) may be encoded and multiplexed with or without encoded UL-SCH, and then transmitted on a PUSCH.

The UCI may be transmitted in the OFDM symbols that are unused for demodulation reference signal (DM-RS) transmission. In any OFDM symbol used for UCI transmission for a UCI type, the mapping of that UCI type depends on the number of resource elements (REs) available for UCI transmission and the remaining REs required for that UCI type. When the number of remaining REs required for that UCI type in an OFDM symbol is greater than half of the available REs for the UCI transmission, the mapping of the UCI type may be contiguous. Otherwise, the mapping may be uniformly distributed across available REs in an OFDM symbol to achieve the diversity gain. The number of coded bits that are occupied in an RE for UCI or data transmission, may be equal to the product of the modulation order and the number of layers.

The coded HARQ-ACK bits may be placed from the OFDM symbol, after the first consecutive DM-RS OFDM symbols. The coded CSI part 1 or part 2 bits may be placed at the starting OFDM symbol that is unused for DM-RS in the shared channel symbol allocation. The multiplexing procedure may depend on the number of HARQ-ACK bits. When the number of HARQ-ACK bits is less than or equal to 2, the coded HARQ-ACK bits may be punctured. Otherwise, the coded HARQ-ACK bits may be rate-matched. Multiplexing procedure may involve the following processing steps:
Step 1: When the number of HARQ-ACK bits is less than or equal to 2, find the reserved HARQ-ACK locations.
Step 2: When the number of HARQ-ACK bits is greater than 2, map the coded HARQ-ACK bits (if any).
Step 3: Map the coded CSI part 1 and CSI part 2 bits (if any).
Step 4: Map the coded UL-SCH bits (if any).
Step 5: When the number of HARQ-ACK bits is less than or equal to 2, map the coded HARQ-ACK bits (if any).
Step 6: Form the codeword.

In some implementations, the HARQ-ACK codebook may be transmitted as a media access control-control element (MAC-CE). In particular, the HARQ-ACK may be carried in the MAC-CE. The UE may multiplex the MAC-CE carrying the HARQ-ACK with media access control service data unit (MAC SDU) at layer 2. Further, the UE may convert the MAC SDU multiplexed with the MAC-CE to a media access control protocol data unit (MAC PDU) at layer 2. Then, the UE may transmit the PUSCH carrying the MAC PDU to the network.

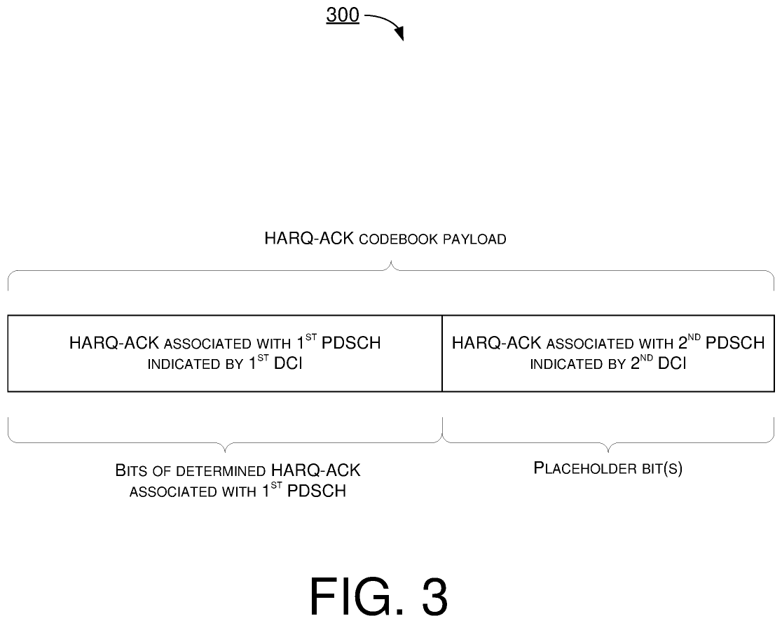

FIG. 3 illustrates an example scenario 300 under schemes in accordance with implementations of the present disclosure. In some implementations, the UE may determine at least one placeholder bit for the HARQ-ACK codebook in an event that a size of the HARQ-ACK codebook is determined. In particular, regarding the PDSCH (i.e., 1^{st} PDSCH) indicated by the DCI (i.e., 1^{st} DCI), the UE may determine a size of a HARQ-ACK associated with the 1^{st} PDSCH. Then, the UE may determine the at least one placeholder bit and attach the at least one placeholder bit to the HARQ-ACK to form the HARQ-ACK codebook when the HARQ-ACK is determined. Therefore, when the UE receives a subsequent DCI (i.e., 2^{nd} DCI) indicating another PDSCH (i.e., 2^{nd} PDSCH), the UE may encode an additional HARQ-ACK associated with the PDSCH indicated by the subsequent DCI to the at least one placeholder bit. In other words, the at least one placeholder bit of the HARQ-ACK codebook may be filled in by the additional HARQ-ACK associated with the PDSCH indicated by the subsequent DCI.

In some cases, a bit size of the at least one placeholder bit may be determined based on physical network resources and a code rate parameter (e.g., maxCodeRate for PUCCH defined in 3GPP specification). In some cases, the bit size of the at least one placeholder bit may be indicated as part of each PUCCH configuration that may be selected. In some cases, the bit size of the at least one placeholder bit may be indicated by the DCI. In some cases, the size of the HARQ-ACK codebook may not be allowed to change irrespective of any timelines. In some cases, the size of the HARQ-ACK codebook may be allowed to change when N4 timeline is abided by, while N4 may refer to the time from receiving HARQ-ACK to the next related action (e.g., retransmission). In some cases, the HARQ-ACK may be repeated in the at least one placeholder bit. In some cases, value of each placeholder bit padded to the HARQ-ACK may be zero. In some cases, in the HARQ-ACK codebook, the HARQ-ACK may be prepended or appended to the at least one placeholder bits.

In some implementations, the DCI may include a codebook index indicating an index of the HARQ-ACK codebook (e.g., one index for Type 1 HARQ-ACK codebook and the other index for Type 2 HARQ-ACK codebook). In particular, the DCI may indicate the codebook index out of a predefined or configured range (e.g., 0 to 1 or 0 to 15), which may allow selecting the Type 1 or Type 2 HARQ-ACK codebook instead of the slot of PUCCH signaled by k1 and k0. In other words, instead of implicitly determining a codebook index by the slot of PUCCH signaled by k1 and k0 in legacy procedure, the codebook index may be explicitly indicated in the DCI.

In some implementations, the UE may determine not to override the PUSCH including the HARQ-ACK codebook for any subsequent DCI. In particular, because the HARQ-ACK codebook may be scheduled onto the PUSCH (i.e., the PSUCH may include the HARQ-ACK) and the HARQ-ACK codebook may be necessarily transmitted to the network node, the UE may determine not to override the PUSCH including the HARQ-ACK codebook for any subsequent DCI, especially DL DCI.

### Illustrative Implementations

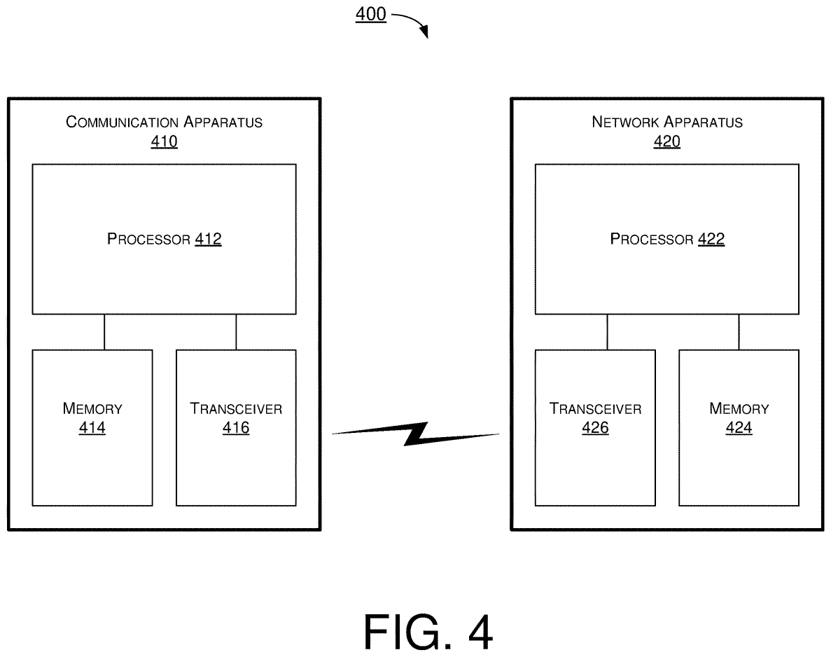

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to HARQ-ACK transmission with respect to UE and network apparatus in mobile communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including HARQ-ACK transmission in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In other words, processor 412 may transceive the data such as configuration, message, signal, information, indicator, etc. via transceiver 416. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In other words, processor 422 may transceive the data such as configuration, message, signal, information, indicator, etc. via transceiver 426. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

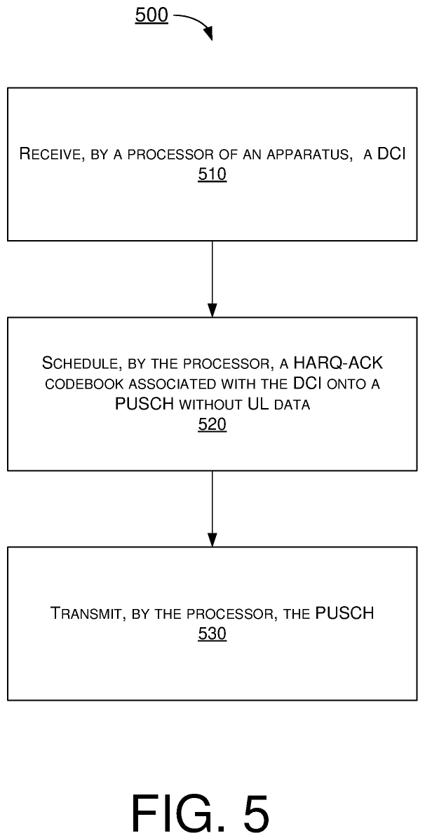

FIG. 5 illustrates an example process 500 in accordance with an implementation of the present disclosure. Process 500 may be an example implementation of above scenarios/schemes, whether partially or completely, with respect to HARQ-ACK transmission of the present disclosure. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 receiving a DCI. Process 500 may proceed from block 510 to block 520.

At block 520, process 500 may involve processor 412 of communication apparatus 410 scheduling a HARQ-ACK codebook associated with the DCI onto a PHSCH without UL data. Process 500 may proceed from block 520 to block 530.

At block 520, process 500 may involve processor 412 of communication apparatus 410 transmitting the PUSCH.

In some implementations, process 500 may involve processor 412 of communication apparatus 410 multiplexing the PUSCH to a dynamic grant scheduled for an UL data. Process 500 may involve processor 412 of communication apparatus 410 transmitting the PUSCH multiplexed to the dynamic grant.

In some implementations, process 500 may involve processor 412 of communication apparatus 410 performing multiplex procedure at layer 1 according to a scheme of UCI over PUSCH.

In some implementations, the HARQ-ACK codebook may be transmitted as a MAC-CE. Process 500 may involve processor 412 of communication apparatus 410 multiplexing the HARQ-ACK codebook with MAC SDU at layer 2.

In some implementations, process 500 may involve processor 412 of communication apparatus 410 determining at least one placeholder bit for the HARQ-ACK codebook in an event that a size of the HARQ-ACK codebook is determined.

In some implementations, process 500 may involve processor 412 of communication apparatus 410 encoding an additional HARQ-ACK associated with a subsequent DCI to the at least one placeholder bit.

In some implementations, the DCI may include a codebook index indicating an index of the HARQ-ACK codebook.

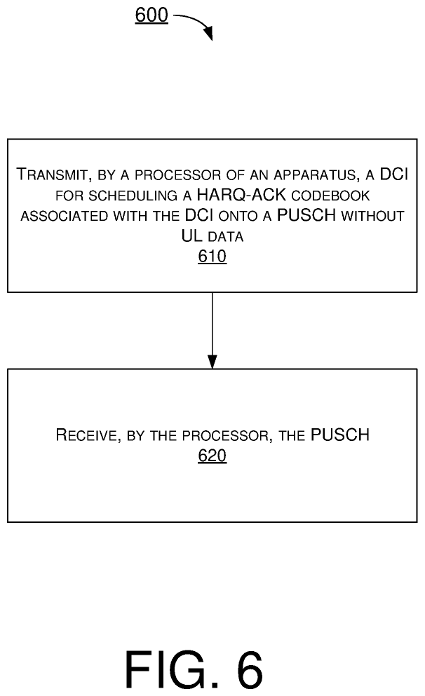

FIG. 6 illustrates an example process 600 in accordance with an implementation of the present disclosure. Process 600 may be an example implementation of above scenarios/schemes, whether partially or completely, with respect to HARQ-ACK transmission of the present disclosure. Process 600 may represent an aspect of implementation of features of network apparatus 420. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable network device or machine type devices. Solely for illustrative purposes and without limitation, process 600 is described below in the context of network apparatus 420. Process 600 may begin at block 610.

At block 610, process 600 may involve processor 422 of network apparatus 420 transmitting a DCI for scheduling a HARQ-ACK codebook associated with the DCI onto a PUSCH without UL data. Process 600 may proceed from block 610 to block 620.

At block 620, process 600 may involve processor 422 of network apparatus 420 receiving the PUSCH.

In some implementations, process 600 may involve processor 422 of network apparatus 420 receiving the PUSCH multiplexed to a dynamic grant scheduled for an UL data.

In some implementations, the HARQ-ACK codebook may be received as MAC-CE multiplexed with MAC SDU at layer 2.

In some implementations, at least one placeholder bit may be determined for the HARQ-ACK codebook in an event that a size of the HARQ-ACK codebook is determined.

In some implementations, process 600 may involve processor 422 of network apparatus 420 transmitting a subsequent DCI for encoding an additional HARQ-ACK associated with the subsequent DCI to the at least one placeholder bit.

In some implementations, the DCI may include a codebook index indicating an index of the HARQ-ACK codebook.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI);
scheduling, by the processor, a hybrid automatic repeat request-acknowledgment (HARQ-ACK) codebook associated with the DCI onto a physical uplink shared channel (PUSCH) without uplink (UL) data; and
transmitting, by the processor, the PUSCH.

2. The method of claim 1, further comprising:
multiplexing, by the processor, the PUSCH to a dynamic grant scheduled for an UL data,
wherein the step of transmitting the PUSCH further comprises:
transmitting the PUSCH multiplexed to the dynamic grant.

3. The method of claim 2, further comprising:
performing, by the processor, a multiplex procedure at layer 1 according to a scheme of uplink control information (UCI) over PUSCH.

4. The method of claim 2, wherein the HARQ-ACK codebook is transmitted as a media access control-control element (MAC-CE), and the method further comprises:
multiplexing, by the processor, the HARQ-ACK codebook with media access control service data unit (MAC SDU) at layer 2.

5. The method of claim 1, further comprising:
determining, by the processor, at least one placeholder bit for the HARQ-ACK codebook in an event that a size of the HARQ-ACK codebook is determined.

6. The method of claim 5, further comprising:
encoding, by the processor, an additional HARQ-ACK associated with a subsequent DCI to the at least one placeholder bit.

7. The method of claim 1, wherein the DCI includes a codebook index indicating an index of the HARQ-ACK codebook.

8. The method of claim 1, further comprising:
determining, by the processor, not to override the PUSCH including the HARQ-ACK codebook for any subsequent downlink (DL) DCI.

9. A method, comprising:
transmitting, by a processor of an apparatus, a downlink control information (DCI) for scheduling a hybrid automatic repeat request-acknowledgment (HARQ-ACK) codebook associated with the DCI onto a physical uplink shared channel (PUSCH) without uplink (UL) data; and
receiving, by the processor, the PUSCH.

10. The method of claim 9, wherein the step of receiving the PUSCH further comprises:
receiving the PUSCH multiplexed to a dynamic grant scheduled for an UL data.

11. The method of claim 10, wherein the HARQ-ACK codebook is received as a media access control-control element (MAC-CE) multiplexed with media access control service data unit (MAC SDU) at layer 2.

12. The method of claim 9, wherein at least one placeholder bit is determined for the HARQ-ACK codebook in an event that a size of the HARQ-ACK codebook is determined.

13. The method of claim 12, further comprising:
transmitting, by the processor, a subsequent DCI for encoding an additional HARQ-ACK associated with the subsequent DCI to the at least one placeholder bit.

14. The method of claim 9, wherein the DCI includes a codebook index indicating an index of the HARQ-ACK codebook.

15. An apparatus, comprising:
a transceiver which, during operation, wirelessly communicates with a wireless network; and
a processor communicatively coupled to the transceiver such that, during operation, the processor performs operations comprising:
receiving, by the transceiver, a downlink control information (DCI);
scheduling a hybrid automatic repeat request-acknowledgment (HARQ-ACK) codebook associated with the DCI onto a physical uplink shared channel (PUSCH) without uplink (UL) data; and
transmitting, via the transceiver, the PUSCH.

16. The apparatus of claim 15, wherein, during operation, the processor further performs operations comprising:
multiplexing the PUSCH to a dynamic grant scheduled for an UL data,
wherein the operation of transmitting the PUSCH further comprises:
transmitting the PUSCH multiplexed to the dynamic grant.

17. The apparatus of claim 16, wherein, during operation, the processor further performs operation comprising:
performing multiplex procedure at layer 1 according to a scheme of uplink control information (UCI) over PUSCH.

18. The apparatus of claim 16, wherein the HARQ-ACK codebook is transmitted as a media access control-control element (MAC-CE), and, during operation, the processor further performs operation comprising:
multiplexing the HARQ-ACK codebook with media access control service data unit (MAC SDU) at layer 2.

19. The apparatus of claim 15, wherein, during operation, the processor further performs operations comprising:
determining at least one placeholder bit for the HARQ-ACK codebook in an event that a size of the HARQ-ACK codebook is determined; and
encoding an additional HARQ-ACK associated with a subsequent DCI to the at least one placeholder bit.

20. The apparatus of claim 15, wherein the DCI includes a codebook identifier indicating a type of the HARQ-ACK codebook.
